(19) United States
(12) Patent Application Publication
(10) Pub. No.: US 2020/0122512 A1
(43) Pub. Date: Apr. 23, 2020

(54) PNEUMATIC TIRE

(71) Applicant: Toyo Tire Corporation, Itami-shi (JP)

(72) Inventor: Toshihiko Kanamura, Itami-shi (JP)

(73) Assignee: Toyo Tire Corporation, Itami-shi (JP)

(21) Appl. No.: 16/582,223

(22) Filed: Sep. 25, 2019

(30) Foreign Application Priority Data
Oct. 22, 2018 (JP) 2018-198678

(51) Int. Cl. B60C 11/03

(52) U.S. Cl. CPC B60C 11/0304; B60C 2011/0358; B60C 2011/0374; B60C 2011/0344

(57) ABSTRACT

In a pneumatic tire, a plurality of main grooves comprise an inboard shoulder main groove that is arranged in inwardmost fashion when the tire is mounted on the vehicle, and an outboard shoulder main groove that is arranged in outwardmost fashion when the tire is mounted on the vehicle, and a distance between an outer edge in a tire width direction of the inboard shoulder main groove and a tire equatorial plane constituting a center in the tire width direction of the tire is greater than a distance between an outer edge in the tire width direction of the outboard shoulder main groove and the tire equatorial plane.

### CROSS REFERENCE TO RELATED APPLICATIONS

This application claims the benefit of priority of Japanese application no. 2018-198678, filed on Oct. 22, 2018, which is incorporated herein by reference.

### BACKGROUND OF THE INVENTION

### Field of the Invention

The present invention relates to a pneumatic tire.

### Description of the Related Art

Conventionally a pneumatic tire might, for example, comprise a plurality of main grooves extending in the tire circumferential direction (e.g., JP2012-116306A). In addition, the plurality of main grooves might comprise an inboard shoulder main groove that is arranged in inwardmost fashion when the tire is mounted on the vehicle, and an outboard shoulder main groove that is arranged in outwardmost fashion when the tire is mounted on the vehicle. In addition, there are situations in which a pneumatic tire might be mounted on a vehicle in such fashion as to have negative camber.

It so happens that a pneumatic tire associated with JP2012-116306A is such that the distance between the outer edge of the inboard shoulder main groove and the tire equatorial plane is less than the distance between the outer edge of the outboard shoulder main groove and the tire equatorial plane. In accordance with such constitution, there will be a decrease in anti-hydroplaning performance (i.e., decreased ability to suppress occurrence of the phenomenon of hydroplaning) and in performance with respect to stability in handling during turns.

### SUMMARY OF THE INVENTION

The problem is therefore to provide a pneumatic tire which when mounted on a vehicle in such fashion as to have negative camber makes it possible to improve anti-hydroplaning performance and performance with respect to stability in handling during turns.

There is provided a pneumatic tire comprises:

a plurality of main grooves extending in a tire circumferential direction; and

an indicator region that indicates an orientation in which the tire is to be mounted on a vehicle;

wherein the plurality of main grooves comprise an inboard shoulder main groove that is arranged in inwardmost fashion when the tire is mounted on the vehicle, and an outboard shoulder main groove that is arranged in outwardmost fashion when the tire is mounted on the vehicle; and

wherein a distance between an outer edge in a tire width direction of the inboard shoulder main groove and a tire equatorial plane constituting a center in the tire width direction of the tire is greater than a distance between an outer edge in the tire width direction of the outboard shoulder main groove and the tire equatorial plane.

Further, the pneumatic tire may have a configuration in which:

wherein a void fraction attributable to an inboard region between the tire equatorial plane and a contact patch end arranged toward the inboard side when the tire is mounted on the vehicle is greater than a void fraction attributable to an outboard region between the tire equatorial plane and a contact patch end arranged toward the outboard side when the tire is mounted on the vehicle.

Further, the pneumatic tire may have a configuration in which:

wherein a void fraction attributable to at least one main groove in the inboard region is greater than a void fraction attributable to at least one main groove in the outboard region.

Further, the pneumatic tire may further include:

a plurality of land portions that are partitioned by the plurality of main grooves and the pair of contact patch ends;

wherein each of the plurality of land portions respectively comprises at least one land groove; and

wherein a void fraction attributable to the at least one land groove in the inboard region is greater than a void fraction attributable to the at least one land groove in the outboard region.

Further, the pneumatic tire may have a configuration in which:

wherein total area of at least one of the main grooves which is arranged to the inboard side of the tire equatorial plane when the tire is mounted on the vehicle is greater than total area of at least one of the main grooves which is arranged to the outboard side of the tire equatorial plane when the tire is mounted on the vehicle.

Further, the pneumatic tire may further include:

a plurality of land portions that are partitioned by the plurality of main grooves and the pair of contact patch ends;

wherein each of the plurality of land portions respectively comprises at least one land groove; and

wherein that land portion which of the land portions is arranged next-to-furthest toward the outboard side when the tire is mounted on the vehicle is in a shape of a rib that extends in continuous fashion in the tire circumferential direction.

Further, the pneumatic tire may have a configuration in which:

wherein each of the grooves has a width, the widths of the grooves increasing with increasing distance from the outboard side when the tire is mounted on the vehicle.

Further, the pneumatic tire may further include:

a plurality of middle land portions that are partitioned by those main grooves which of the plurality of main grooves are respectively adjacent thereto;

wherein each of the middle land portions has a width, the widths of the middle land portions increasing with increasing distance from the inboard side when the tire is mounted on the vehicle.

Further, the pneumatic tire may further include:

at least one middle land portion that is partitioned by those main grooves which of the plurality of main grooves are respectively adjacent thereto;

wherein the at least one middle land portion comprises a plurality of land grooves;

wherein the main grooves respectively adjacent thereto comprise a first main groove and a second main groove having a width larger than a width of the first main groove; and

wherein the plurality of land grooves are contiguous with the second main groove but are separated from the first main groove.

### BRIEF DESCRIPTION OF DRAWINGS

FIG. 1 is a view of a section, taken along a tire meridional plane, of the principal components in a pneumatic tire associated with an embodiment;

FIG. 2 is a drawing showing a tread surface of the principal components in a pneumatic tire associated with same embodiment as they would exist if unwrapped so as to lie in a single plane;

FIG. 3 is a drawing showing the shape of the contact patch at a pneumatic tire associated with same embodiment when driving straight ahead;

FIG. 4 is a drawing showing the shape of the contact patch at a pneumatic tire associated with same embodiment on an outside wheel during a turn; and

FIG. 5 is a table showing results of evaluation of examples and comparative examples.

### DETAILED DESCRIPTION OF THE INVENTION

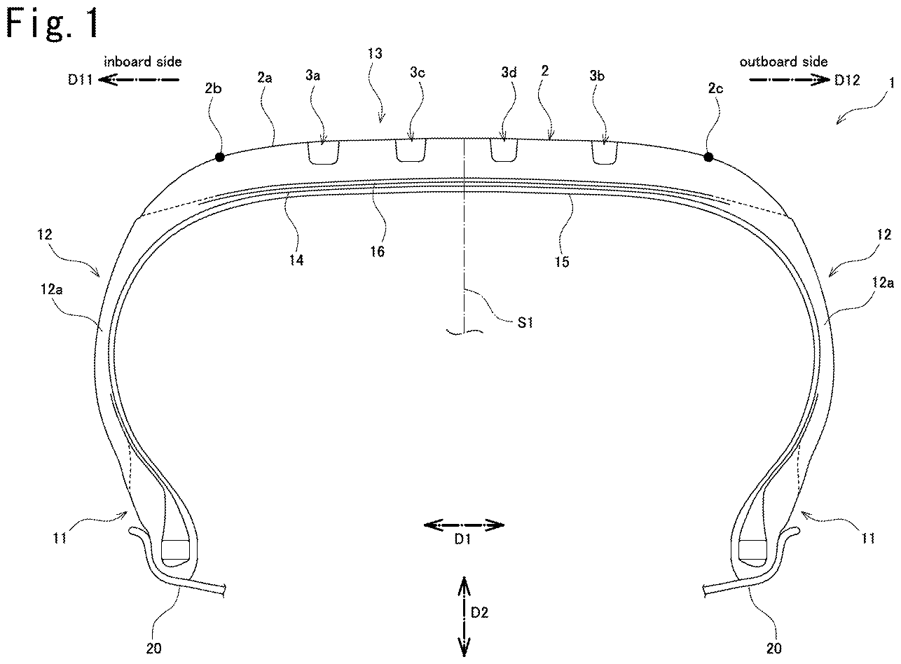

Below, an embodiment of a pneumatic tire is described with reference to FIG. 1 through FIG. 4. At the respective drawings, note that dimensional ratios at the drawings and actual dimensional ratios are not necessarily consistent, and note further that dimensional ratios are not necessarily consistent from drawing to drawing.

At the respective drawings, first direction D1 is the tire width direction D1 which is parallel to the tire rotational axis which is the center of rotation of pneumatic tire (hereinafter also referred to as simply “tire”) 1, second direction D2 is the tire radial direction D2 which is the direction of the diameter of tire 1, and third direction D3 is the tire circumferential direction D3 which is circumferential with respect to the rotational axis of the tire.

In the tire width direction D1, note that the side toward the interior is the side which is nearer to tire equatorial plane S1, and note that the side toward the exterior is the side which is farther from tire equatorial plane S1. Furthermore, in the tire radial direction D2, the side toward the interior is the side which is nearer to the tire rotational axis, and the side toward the exterior is the side away from the tire rotational axis.

Tire equatorial plane S1 refers to a plane that is located centrally in the tire width direction D1 of tire 1 and that is perpendicular to the rotational axis of the tire; tire meridional planes refer to planes that are perpendicular to tire equatorial plane S1 and that contain the rotational axis of the tire. Furthermore, the tire equator is the curve formed by the intersection of tire equatorial plane S1 and the outer surface (tread surface 2a, described below) in the tire radial direction D2 of tire 1.

As shown in FIG. 1, tire 1 associated with the present embodiment is provided with a pair of bead regions 11 at which beads are present; sidewall regions 12 which extend outwardly in the tire radial direction D2 from the respective bead regions 11; and tread region 13, the exterior surface in the tire radial direction D2 of which contacts the road surface and which is contiguous with the outer ends in the tire radial direction D2 of the pair of sidewall regions 12. In accordance with the present embodiment, tire 1 is a pneumatic tire 1, the interior of which is capable of being filled with air, and which is capable of being mounted on a rim 20.

Furthermore, tire 1 is provided with carcass layer 14 which spans the pair of beads, and innerliner layer 15 which is arranged at a location toward the interior from carcass layer 14 and which has superior functionality in terms of its ability to impede passage of gas therethrough so as to permit air pressure to be maintained. Carcass layer 14 and innerliner layer 15 are arranged in parallel fashion with respect to the inner circumferential surface of the tire over a portion thereof that encompasses bead regions 11, sidewall regions 12, and tread region 13.

Tire 1 has a structure that is asymmetric with respect to tire equatorial plane S1. In accordance with the present embodiment, tire 1 is a tire for which a vehicle mounting direction is indicated, which is to say that there is an indication of whether the left or the right side of the tire 1 should be made to face the vehicle when tire 1 mounted on rim 20. Moreover, the tread pattern formed at the tread surface 2a at tread region 13 is asymmetric with respect to tire equatorial plane S1.

The orientation in which the tire is to be mounted on the vehicle is indicated at sidewall region 12. More specifically, sidewall region 12 is provided with sidewall rubber 12a which is arranged toward the exterior in the tire width direction D1 from carcass layer 14 so as to constitute the tire exterior surface, said sidewall rubber 12a have an indicator region (not shown) at surface.

For example, one sidewall region 12, i.e., that which is to be arranged toward the interior D11 when the tire is mounted on the vehicle (the left side in the respective drawings; hereinafter also referred to as the “inboard side”), might be marked (e.g., with the word “INSIDE” or the like) so as to contain an indication to the effect that it is for the inboard side. Furthermore, for example, the other sidewall region 12, i.e., that which is to be arranged toward the exterior D12 when the tire is mounted on the vehicle (the right side in the respective drawings; hereinafter also referred to as the “outboard side”), might be marked (e.g., with the word “OUTSIDE” or the like) so as to contain an indication to the effect that it is for the outboard side. Note that the inboard side D11 is the side which is nearer to the vehicle center when tire 1 is mounted on the vehicle, and the outboard side D12 is the side which is farther from the vehicle center when tire 1 is mounted on the vehicle.

Tread region 13 is provided with tread rubber 2 having tread surface 2a which contacts the road surface, and belt layer 16 which is arranged between tread rubber 2 and carcass layer 14. Present at tread surface 2a is the contact patch that actually comes in contact with the road surface, and the portions within said contact patch that are present at the outer ends in the tire width direction D1 are referred to as contact patch ends 2b, 2c.

Note that contact patch end 2b, which of contact patch ends 2b, 2c is that which is arranged toward the inboard side D11, is referred to as inboard contact patch end 2b; and contact patch end 2c, which of contact patch ends 2b, 2c is that which is arranged toward the outboard side D12, is referred to as outboard contact patch end 2c. Further that said contact patch refers to the portion of the tread surface 2a that comes in contact with the road surface when a normal lead is applied to a tire 1 mounted on a normal rim 20 when the tire 1 is inflated to normal internal pressure and is placed in vertical orientation on a flat road surface.

Normal rim 20 is that particular rim 20 which is specified for use with a particular tire 1 in the context of the body of standards that contains the standard that applies to the tire 1 in question, this being referred to, for example, as a standard rim in the case of JATMA, a “Design Rim” in the case of TRA, or a “Measuring rim” in the case of ETRTO.

Normal internal pressure is that air pressure which is specified for use with a particular tire 1 in the context of the body of standards that contains the standard that applies to the tire 1 in question, this being maximum air pressure in the case of JATMA, the maximum value listed at the table entitled “TIRE LOAD LIMITS AT VARIOUS COLD INFLATION PRESSURES” in the case of TRA, or “INFLATION PRESSURE” in the case of ETRTO, which when tire 1 is to used on a passenger vehicle is taken to be an internal pressure of 190 KPa.

Normal load is that load which is specified for use with a particular tire 1 in the context of the body of standards that contains the standard that applies to the tire 1 in question, this being maximum load capacity in the case of JATMA, the maximum value listed at the aforementioned table in the case of TRA, or “LOAD CAPACITY” in the case of ETRTO, which when tire 1 is to be used on a passenger vehicle is taken to be 85% of the load corresponding to an internal pressure of 180 KPa.

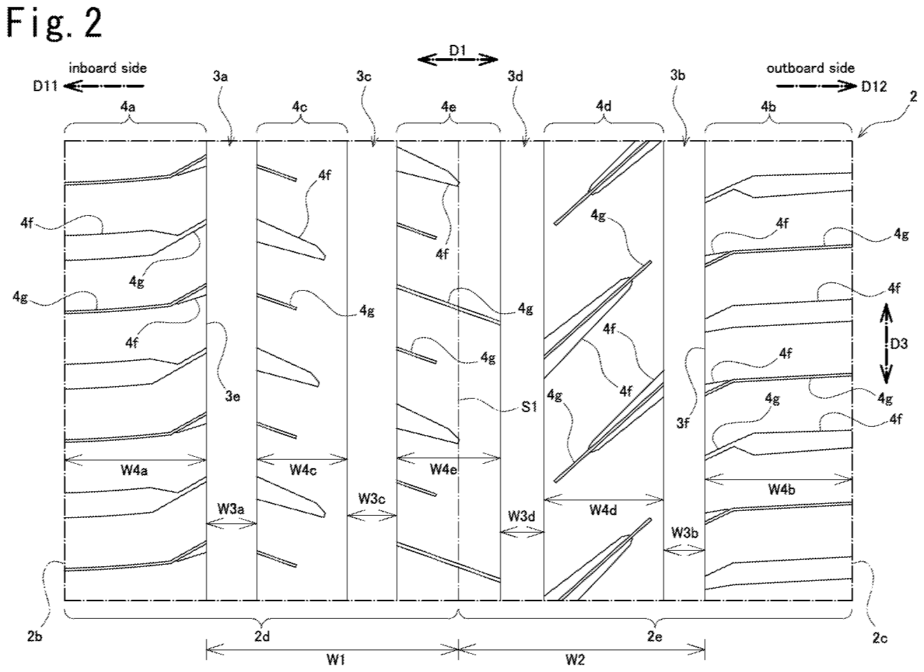

As shown in FIG. 1 and FIG. 2, tread rubber 2 is provided with a plurality of main grooves 3a through 3d extending in the tire circumferential direction D3. Each of the plurality of Main groove 3a through 3d respectively extends continuously in the tire circumferential direction D3.

Main groove 3a through 3d might, for example, be provided with so-called tread wear indicator(s) (not shown) which are portions at which depth of the groove is reduced so as to make it possible to ascertain the extent to which wear has occurred as a result of the exposure thereof that takes place in accompaniment to wear. Furthermore, main groove 3a through 3d might, for example, have a width that is not less than 3% of the distance (dimension in the tire width direction D1) between contact patch ends 2b, 2c. Furthermore, main groove 3a through 3d might, for example, have a width that is not less than 5 mm.

Furthermore, at the plurality of Main groove 3a through 3d, pair of main grooves 3a, 3b arranged at outermost locations in the tire width direction D1 are referred to as shoulder main grooves 3a, 3b, and main grooves 3c, 3d arranged between the pair of shoulder main grooves 3a, 3b are referred to as center main grooves 3c, 3d. In accordance with the present embodiment, the number of center main grooves 3c, 3d that are present is two.

At the shoulder main grooves 3a, 3b, shoulder main groove 3a which is arranged toward the vehicle inboard side D11 is referred to as inboard shoulder main groove 3a, and shoulder main groove 3b which is arranged toward the vehicle outboard side D12 is referred to as outboard shoulder main groove 3b. At the center main grooves 3c, 3d, center main groove 3c which is arranged toward the vehicle inboard side D11 is referred to as inboard center main groove 3c, and center main groove 3d which is arranged toward the vehicle outboard side D12 is referred to as outboard center main groove 3d.

As shown in FIG. 2, tread rubber 2 comprises inboard region 2d, which is that portion of the contact patch which is arranged toward the inboard side D11 thereof; and outboard region 2e, which is that portion of the contact patch which is arranged toward the outboard side D12 thereof. Inboard region 2d is the region between tire equatorial plane S1 and inboard contact patch end 2b, and outboard region 2e is the region between tire equatorial plane S1 and outboard contact patch end 2c.

Furthermore, tread rubber 2 comprises a plurality of land portions 4a through 4e that are partitioned by main grooves 3a through 3d and contact patch ends 2b, 2c. At the plurality of land portions 4a through 4e, land portions 4a, 4b which are partitioned by shoulder main grooves 3a, 3b and contact patch ends 2b, 2c and which are arranged toward the exterior in the tire width direction D1 from shoulder main grooves 3a, 3b are referred to as shoulder land portions 4a, 4b, and land portions 4c through 4e which are partitioned by respective main grooves 3a through 3d adjacent thereto and which are arranged between the pair of shoulder land portions 4a, 4b are referred to as middle land portions 4c through 4e.

Note, of the middle land portions 4c through 4e, that land portions 4c, 4d which are partitioned by shoulder main groove 3a, 3b and center main groove 3c, 3d are referred to as mediate land portions 4c, 4d, and that land portion 4e which is partitioned by the center main grooves 3c, 3d is referred to as center land portion 4e. In accordance with the present embodiment, center main grooves 3c, 3d are arranged so as to straddle tire equatorial plane S1, this being the case, center land portion 4e are arranged in such fashion as to contain tire equatorial plane S1.

At the shoulder land portions 4a, 4b, shoulder land portion 4a which is arranged toward the vehicle inboard side D11 is referred to as inboard shoulder land portion 4a, and shoulder land portion 4b which is arranged toward the vehicle outboard side D12 is referred to as outboard shoulder land portion 4b. At the mediate land portions 4c, 4d, mediate land portion 4c arranged toward the vehicle inboard side D11 is referred to as inboard mediate land portion 4c, and mediate land portion 4d arranged toward the vehicle outboard side D12 is referred to as outboard mediate land portion 4d.

The land portions 4a through 4e are provided with a plurality of land grooves 4f, 4g. The plurality of land grooves 4f, 4g extend so as to intersect the tire circumferential direction D3. In addition, of the land grooves 4f, 4g that extend so as to intersect the tire circumferential direction D3, land groove(s) 4f of groove width not less than 1.2 mm are referred to as width groove(s) 4f, and land groove(s) 4g of groove width less than 1.2 mm are referred to as sipe(s) 4g. Note, moreover, that land portions 4a through 4e may be provided with land groove(s) that extend in continuous or intermittent fashion in the tire circumferential direction D3 and that are of groove width(s) less than the groove width(s) of main grooves 3a through 3d, such land groove(s) being referred to as circumferential groove(s).

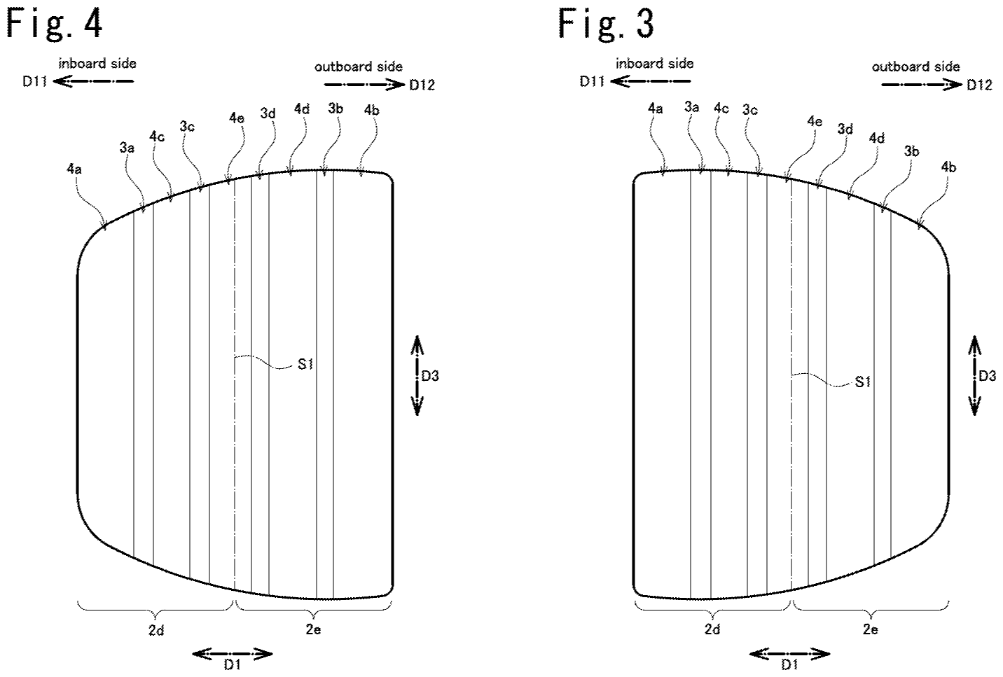

But when tire 1 is mounted on a vehicle in such fashion as to have negative camber, it will be inclined in such a direction as to cause it to be directed from the outboard side D12 to the inboard side D11 as one proceeds from the bottom thereof to the top thereof. As a result, as shown in FIG. 3, the shape of the contact patch of tire 1 when driving straight ahead (land grooves 4f, 4g are not shown at FIG. 3) will be such that contact patch length (length in the tire circumferential direction D3) will be greater the further one goes toward the inboard side D11.

As a result, there is a tendency for accumulation of water to occur at inboard region 2d which is arranged toward the inboard side D11. In particular, there is a tendency for accumulation of water to occur at inboard shoulder land portion 4a which is arranged furthest toward the inboard side D11. Accordingly, ability to suppress the tendency for accumulation of water to occur at inboard region 2d, and in particular at inboard shoulder land portion 4a, would make it possible to improve anti-hydroplaning performance.

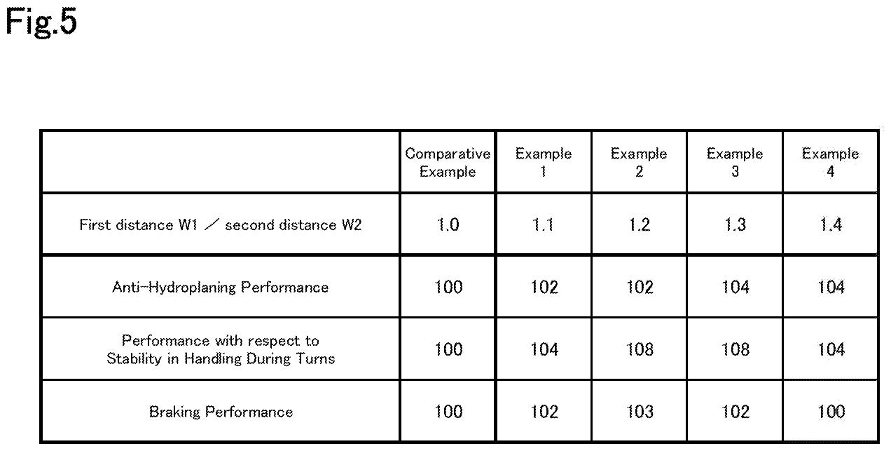

On the other hand, as shown in FIG. 4, the shape of the contact patch of tire 1 on an outside wheel during a turn (land grooves 4f, 4g are not shown at FIG. 4) will be such that contact patch length will be greater the further one goes toward the outboard side D12. This is because the further one goes toward the outboard side D12 the greater will be the force that acts thereat. Accordingly, ability to increase rigidity at outboard region 2e, and in particular at outboard shoulder land portion 4b, would make it possible to improve performance with respect to stability in handling during turns.

Description is therefore first given below regarding the constitution with respect to the positions of inboard shoulder main groove 3a and outboard shoulder main groove 3b.

Returning to FIG. 2, first distance W1 between the outer edge 3e (edge 3e on the inboard side D11) in the tire width direction D1 of inboard shoulder main groove 3a and tire equatorial plane S1 is greater than second distance W2 between outer edge 3f (edge 3f on the outboard side D12) in the tire width direction D1 of outboard shoulder main groove 3b and tire equatorial plane S1. This being the case, width (dimension in the tire width direction D1) W4a of inboard shoulder land portion 4a will be less than width W4b of outboard shoulder land portion 4b.

Because it is thus possible to suppress increase in width W4a of inboard shoulder land portion 4a, it will be possible to suppress occurrence of a situation in which the region of the contact patch at inboard shoulder land portion 4a when driving straight ahead becomes too large when the tire is mounted on a vehicle in such fashion as to have negative camber. Accordingly, it will be possible to suppress the tendency for water to accumulate at inboard shoulder land portion 4a. As a result, improvement in anti-hydroplaning performance is made possible.

On the other hand, because width W4b of outboard shoulder land portion 4b will be large, the volume of the rubber at outboard shoulder land portion 4b will be large. As a result, because there will be increase in rigidity at outboard shoulder land portion 4b, it will be possible to improve performance with respect to stability in handling during turns.

Moreover, while there is no particular limitation with respect to the ratio (W1/W2) of the first distance W1 to the second distance W2, where the constitution is such that this is greater than 1, it is, for example, preferred that this be not greater than 1.3. For example, if said ratio (W1/W2) is not greater than 1.3, it will be possible to suppress increase in the difference between the contact patch area attributable to inboard shoulder land portion 4a and the contact patch area attributable to outboard shoulder land portion 4b when driving straight ahead when the tire is mounted on a vehicle in such fashion as to have negative camber.

As a result, it will be possible to suppress increase in the difference between the contact patch pressure at inboard shoulder land portion 4a and the contact patch pressure at outboard shoulder land portion 4b. Accordingly, because it will be possible to suppress reduction in the overall coefficient of friction of tire 1, it will be possible to suppress reduction in braking performance.

Description will now be given in terms of the constitution with respect to the void fraction at grooves 3a through 3d and 4f and 4g (the area of grooves 3a through 3d and 4f and 4g). Void fraction refers to the ratio of groove area (the sum of the area of main grooves 3a through 3d and the area of land grooves 4f, 4g) to contact patch area (the sum of the area of main grooves 3a through 3d and the area of land portions 4a through 4e (including land grooves 4f, 4g)).

It is first noted that the total area of main grooves 3a, 3c which are arranged to the inboard side D11 of tire equatorial plane S1 is larger than the total area of main grooves 3b, 3d which are arranged to the outboard side D12 of tire equatorial plane S1. In addition, because main grooves 3a through 3d are straight main grooves, the sum of widths (the dimension in the tire width direction D1) W3a, W3c of main grooves 3a, 3c which are arranged to the inboard side D11 of tire equatorial plane S1 is greater than the sum of widths W3b, W3d of main grooves 3b, 3d which are arranged to the outboard side D12 of tire equatorial plane S1.

Accordingly, the void fraction attributable to main grooves 3a, 3c at inboard region 2d is greater than the void fraction attributable to main grooves 3b, 3d at outboard region 2e. And not only that, but the void fraction attributable to land grooves 4f, 4g at inboard region 2d is also greater than the void fraction attributable to land grooves 4f, 4g at outboard region 2e. The void fraction attributable to inboard region 2d is thus greater than the void fraction attributable to outboard region 2e.

As a result, when the tire is mounted on a vehicle in such fashion as to have negative camber, to address the fact that the contact patch length at inboard region 2d will be greater than the contact patch length at outboard region 2e, the area of grooves 3a, 3c, 4f, 4g at inboard region 2d is increased. Accordingly, it will be possible to suppress the tendency for water to accumulate at inboard region 2d. As a result, improvement in anti-hydroplaning performance is made possible.

On the other hand, it will also be possible to suppress increase in the area of grooves 3b, 3d, 4f, 4g at outboard region 2e. As a result, because the volume of the rubber at outboard region 2e will be large, there will be an increase in rigidity at outboard shoulder land portion 4b. As a result, it will be possible to improve performance with respect to stability in handling during turns.

It so happens that in accordance with the present embodiment the greater the extent to which main grooves 3a, 3c, 3d, 3b are located toward inboard side D11 the greater will be groove widths W3a, W3c, W3d, W3b. More specifically, width W3a of inboard shoulder main groove 3a is larger than width W3c of inboard center main groove 3c, width W3c of inboard center main groove 3c is larger than width W3d of outboard center main groove 3d, and width W3d of outboard center main groove 3d is larger than width W3b of outboard shoulder main groove 3b.

As a result, when driving straight ahead when the tire is mounted on a vehicle in such fashion as to have negative camber, to address the fact that contact patch length will increase as one proceeds toward inboard side D11, the greater the extent to which a main groove 3a, 3c, 3d, 3b is located toward inboard side D11 the greater is the groove width W3a, W3c, W3d, W3b. As a result, further improvement in anti-hydroplaning performance is made possible. Note, however, that there is no particular limitation with respect to the relative magnitudes of widths W3a through W3d of main grooves 3a through 3d.

Next, the constitution associated with middle land portions 4c through 4e will be described below.

Among middle land portions 4c through 4e, at an outside wheel during a turn, the greatest force will act on outboard mediate land portion 4d. To address this, outboard mediate land portion 4d is in the shape of a rib extending in continuous fashion in the tire circumferential direction D3. As a result, because there will be increase in rigidity at outboard mediate land portion 4d, it will be possible to further improve performance with respect to stability in handling during turns.

Note that term rib-shaped as used herein refers to the shape of land portions 4a and 4c through 4e which are not divided in the tire circumferential direction D3 by width groove 4f. Conversely, land portion 4b which is divided in the tire circumferential direction D3 by width groove 4f is referred to as being block-shaped. Accordingly, at each of rib-shaped land portions 4a and 4c through 4e, at least one end of width groove 4f is located not at a main groove 3a through 3d but is located at the interior of the land portion 4a and 4c through 4e.

It so happens that in accordance with the present embodiment the greater the extent to which middle land portions 4d, 4e, 4c are located toward outboard side D12 the greater will be groove widths W4d, W4e, W4c. More specifically, width W4d of outboard mediate land portion 4d is greater than width W4e of center land portion 4e, and width W4e of center land portion 4e is greater than width W4c of inboard mediate land portion 4c.

As a result, at an outside wheel during a turn, to address the fact that the greater the extent to which a middle land portion 4d, 4e, 4c is located toward outboard side D12 the greater will be the force that acts thereat, the greater the extent to which a middle land portion 4d, 4e, 4c is located toward outboard side D12 the greater is the rigidity thereat. As a result, it will be possible to further improve performance with respect to stability in handling during turns. Note, however, that there is no particular limitation with respect to the relative magnitudes of widths W4c through W4e of middle land portions 4c through 4e.

Furthermore, inboard mediate land portion 4c is adjacent to inboard shoulder main groove 3a and inboard center main groove 3c, and width W3a of inboard shoulder main groove 3a is greater than width W3c of inboard center main groove 3c. Furthermore, at each width groove 4f in inboard mediate land portion 4c, a first end is contiguous with inboard shoulder main groove 3a, and a second end is separated from inboard center main groove 3c.

As a result, water shedding by width grooves 4f at inboard mediate land portion 4c will take place by way of main groove 3a, which of the main grooves 3a, 3c that are adjacent thereto is the one of larger width W3a. Accordingly, it will be possible to suppress the tendency for water to accumulate at inboard mediate land portion 4c. As a result, further improvement in anti-hydroplaning performance is made possible.

Moreover, at inboard mediate land portion 4c on an outside wheel during a turn, to address the fact that the force that acts thereat will be greater toward outboard side D12 than it will be toward inboard side D11, the portion thereof toward outboard side D12 is not divided by width groove 4f but is continuous in the tire circumferential direction D3. As a result, because there will be increase in rigidity at the portion thereof toward outboard side D12, it will be possible to further improve performance with respect to stability in handling during turns.

Furthermore, center land portion 4e is adjacent to inboard center main groove 3c and outboard center main groove 3d, and width W3c of inboard center main groove 3c is greater than width W3d of outboard center main groove 3d. Furthermore, at each width groove 4f in center land portion 4e, a first end is contiguous with inboard center main groove 3c, and a second end is separated from outboard center main groove 3d.

As a result, water shedding by width grooves 4f at center land portion 4e will take place by way of main groove 3c, which of the main grooves 3c, 3d that are adjacent thereto is the one of larger width W3c. Accordingly, it will be possible to suppress the tendency for water to accumulate at center land portion 4e. As a result, further improvement in anti-hydroplaning performance is made possible.

Moreover, at center land portion 4e on an outside wheel during a turn, to address the fact that the force that acts thereat will be greater toward outboard side D12 than it will be toward inboard side D11, the portion thereof toward outboard side D12 is not divided by width groove 4f but is continuous in the tire circumferential direction D3. As a result, because there will be increase in rigidity at the portion thereof toward outboard side D12, it will be possible to further improve performance with respect to stability in handling during turns.

As described above, the pneumatic tire 1 of the embodiment includes: a plurality of main grooves 3a through 3d extending in a tire circumferential direction D3; and an indicator region that indicates an orientation in which the tire is to be mounted on a vehicle; wherein the plurality of main grooves 3a through 3d comprise an inboard shoulder main groove 3a that is arranged in inwardmost fashion when the tire is mounted on the vehicle, and an outboard shoulder main groove 3b that is arranged in outwardmost fashion when the tire is mounted on the vehicle; and wherein a distance W1 between an outer edge 3e in a tire width direction D1 of the inboard shoulder main groove 3a and a tire equatorial plane S1 constituting a center in the tire width direction D1 of the tire 1 is greater than a distance W2 between an outer edge 3f in the tire width direction D1 of the outboard shoulder main groove 3b and the tire equatorial plane S1.

In accordance with such constitution, because distance W1 between outer edge 3e in the tire width direction D1 of inboard shoulder main groove 3a and tire equatorial plane S1 is large, width W4a of land portion 4a arranged furthest toward the inboard side D11 when the tire is mounted on the vehicle will be small. As a result, when the tire is mounted on a vehicle in such fashion as to have negative camber, while contact patch length toward inboard side D11 will be greater than contact patch length toward outboard side D12, it will be possible to suppress occurrence of a situation in which the region of the contact patch at land portion 4a which is arranged furthest toward the inboard side D11 becomes too large.

Accordingly, at land portion 4a which is arranged furthest toward the inboard side D11, it will be possible to suppress the tendency for water to accumulate. As a result, when the tire is mounted on a vehicle in such fashion as to have negative camber, it will be possible to improve anti-hydroplaning performance.

Furthermore, because distance W2 between outer edge 3f in the tire width direction D1 of outboard shoulder main groove 3b and tire equatorial plane S1 is small, width W4b of land portion 4b arranged furthest toward the outboard side D12 when the tire is mounted on the vehicle will be large. As a result, the volume of the rubber at land portion 4b arranged furthest toward the outboard side D12 when the tire is mounted on the vehicle will be large.

Accordingly, at an outside wheel during a turn, to address the fact that a large force will act at outboard region 2e, rigidity at land portion 4b arranged furthest toward the outboard side D12 is increased. As a result, it will be possible to improve performance with respect to stability in handling during turns.

Further, in the pneumatic tire 1 of the embodiment, wherein a void fraction attributable to an inboard region 2d between the tire equatorial plane S1 and a contact patch end 2b arranged toward the inboard side D11 when the tire is mounted on the vehicle is greater than a void fraction attributable to an outboard region 2e between the tire equatorial plane S1 and a contact patch end 2c arranged toward the outboard side D12 when the tire 1 is mounted on the vehicle.

In accordance with such constitution, the void fraction attributable to region 2d between tire equatorial plane S1 and contact patch end 2b arranged toward the inboard side D11 when the tire is mounted on the vehicle is high. As a result, when the tire is mounted on a vehicle in such fashion as to have negative camber, to address the fact that the contact patch length at inboard region 2d will be greater than the contact patch length at outboard region 2e, the area of grooves 3a through 3d and 4f and 4g at inboard region 2d is increased.

Accordingly, at inboard region 2d, it will be possible to suppress the tendency for water to accumulate. As a result, when the tire is mounted on a vehicle in such fashion as to have negative camber, it will be possible to further improve anti-hydroplaning performance.

Furthermore, because the void fraction attributable to region 2e between tire equatorial plane S1 and contact patch end 2c arranged toward the outboard side D12 when the tire is mounted on the vehicle is low, the volume of the rubber at outboard region 2e is made large. As a result, at an outside wheel during a turn, while a large force will act at outboard region 2e, because rigidity at outboard region 2e will be high, it will be possible to further improve performance with respect to stability in handling during turns.

Further, in the pneumatic tire 1 of the embodiment, wherein total area of at least one of the main grooves 3a, 3c which is arranged to the inboard side D11 of the tire equatorial plane S1 when the tire is mounted on the vehicle is greater than total area of at least one of the main grooves 3b, 3d which is arranged to the outboard side D12 of the tire equatorial plane S1 when the tire is mounted on the vehicle.

In accordance with such constitution, the total area of main grooves 3a, 3c arranged to the inboard side D11 of tire equatorial plane S1 is large. As a result, when the tire is mounted on a vehicle in such fashion as to have negative camber, to address the fact that the contact patch length at inboard region 2d will be greater than the contact patch length at outboard region 2e, the area of main grooves 3a, 3c at inboard region 2d is increased.

Accordingly, at inboard region 2d, it will be possible to suppress the tendency for water to accumulate. As a result, when the tire is mounted on a vehicle in such fashion as to have negative camber, it will be possible to further improve anti-hydroplaning performance.

Furthermore, because the total area of main grooves 3b, 3d arranged to the outboard side D12 of tire equatorial plane S1 is small, the volume of the robber at outboard region 2e will be large. As a result, at an outside wheel during a turn, while a large force will act at outboard region 2e, because rigidity at outboard region 2e will be high, it will be possible to further improve performance with respect to stability in handling during turns.

Further, the pneumatic tire 1 of the embodiment includes: a plurality of land portions 4a through 4e that are partitioned by the plurality of main grooves 3a through 3d and the pair of contact patch ends 2b, 2c; wherein each of the plurality of land portions 4a through 4e respectively comprises at least one land groove 4f, 4g; and wherein that land portion 4d which of the land portions 4a through 4e is arranged next-to-furthest toward the outboard side D12 when the tire is mounted on the vehicle is in a shape of a rib that extends in continuous fashion in the tire circumferential direction D3.

In accordance with such constitution, land portion 4d which is arranged next-to-furthest toward the outboard side D12 when the tire is mounted on a vehicle is not block-shaped, i.e., divided in the tire circumferential direction D3; but is rib-shaped, i.e., extends in continuous fashion in the tire circumferential direction D3. As a result, at an outside wheel during a turn, while a large force will act at outboard region 2e, because rigidity at said land portion 4d will be high, it will be possible to further improve performance with respect to stability in handling during turns.

The pneumatic tire 1 is not limited to the configuration of the embodiment described above, and the effects are not limited to those described above. It goes without saying that the pneumatic tire 1 can be variously modified without departing from the scope of the subject matter of the present invention. For example, the constituents, methods, and the like of various modified examples described below may be arbitrarily selected and employed as the constituents, methods, and the like of the embodiments described above, as a matter of course.

(1) The constitution of pneumatic tire 1 associated with the foregoing embodiment is such that the void fraction attributable to inboard region 2d is greater than the void fraction attributable to outboard region 2e. However, while such constitution is preferred, pneumatic tire 1 is not limited to such constitution. For example, it is also possible to adopt a constitution in which the void fraction attributable to inboard region 2d is not greater than the void fraction attributable to outboard region 2e.

(2) Furthermore, the constitution of pneumatic tire 1 associated with the foregoing embodiment is such that the total area of main grooves 3a, 3c arranged to the inboard side D11 of tire equatorial plane S1 is greater than the total area of main grooves 3b, 3d arranged to the outboard side D12 of tire equatorial plane S1. However, while such constitution is preferred, pneumatic tire 1 is not limited to such constitution. For example, it is also possible to adopt a constitution in which the total area of main grooves 3a, 3c arranged to the inboard side D11 of tire equatorial plane S1 is not greater than the total area of main grooves 3b, 3d arranged to the outboard side D12 of tire equatorial plane S1.

(3) Furthermore, the constitution of pneumatic tire 1 associated with the foregoing embodiment is such that land portion 4d which is arranged next-to-furthest toward the outboard side D12 is in the shape of a rib extending in continuous fashion in the tire circumferential direction D3. However, while such constitution is preferred, pneumatic tire 1 is not limited to such constitution. For example, it is also possible to adopt a constitution in which land portion 4d which is arranged next-to-furthest toward the outboard side D12 is in the shape of blocks, being divided in the tire circumferential direction D3.

(4) Furthermore, the constitution of pneumatic tire 1 associated with the foregoing embodiment is such that the number of main grooves 3a through 3d that are present is four. However, pneumatic tire 1 is not limited to such constitution. For example, it is also possible to adopt a constitution in which the number of main grooves 3a through 3d that are present is two or three or is five or more.

(5) Furthermore, the constitution of pneumatic tire 1 associated with the foregoing embodiment is such that main grooves 3a through 3d are straight main grooves that extend in parallel fashion with respect to the tire circumferential direction D3. However, pneumatic tire 1 is not limited to such constitution. For example, it is also possible to adopt a constitution in which main groove(s) 3a through 3d extend in zigzag fashion along the tire circumferential direction D3. In the context of such constitution, the locations of outer edges 3e, 3f in the tire width direction D1 of main grooves 3a, 3b are the average locations in the tire width direction D1 of outer edges 3e, 3f of main grooves 3a, 3b.

(6) Furthermore, the constitution of pneumatic tire 1 associated with the foregoing embodiment is such that widths W3a through W3d of main grooves 3a through 3d are the same at all locations in the tire circumferential direction D3. However, pneumatic tire 1 is not limited to such constitution. For example, it is also possible to adopt a constitution in which width(s) W3a through W3d of main groove(s) 3a through 3d vary. In the context of such constitution, widths W3a through W3d of main grooves 3a through 3d are the average values of widths W3a through W3d of main grooves 3a through 3d.

(7) Furthermore, the constitution of pneumatic tire 1 associated with the foregoing embodiment is such that widths W4a through W4e of land portions 4a through 4e are the same at all locations in the tire circumferential direction D3. However, pneumatic tire 1 is not limited to such constitution. For example, it is also possible to adopt a constitution in which width(s) W4a through W4e of land portion(s) 4a through 4e vary. In the context of such constitution, widths W4a through W4e of land portions 4a through 4e are the average values of widths W4a through W4e of land portions 4a through 4e.

### EXAMPLES

To illustrate the constitution and effect of tire 1 in specific terms, examples of tire 1 as well as comparative examples thereof are described below with reference to FIG. 5.

<Anti-Hydroplaning Performance>

The respective tires were mounted on a vehicle in such fashion as to have negative camber, and with wheels on one side traveling straight ahead on a wet road for which water depth was 8 mm and wheels on the other side traveling straight ahead on a dry road, the speed necessary to cause the difference in percent slip between the left-side wheels and right-side wheels to reach 10% was measured. Results of evaluation are shown as indexed relative to a value of 100 for the Comparative Example, the larger the index the less likely the tendency for hydroplaning to occur and the better the anti-hydroplaning performance.

<Performance with Respect to Stability in Handling During Turns>

The respective tires were mounted on a vehicle in such fashion as to have negative camber, and driving was carried out with turns on a dry road. In addition, sensory tests carried out by the driver were employed for the purpose of evaluating performance with respect to stability in handling. Results of evaluation are shown as indexed relative to a value of 100 for the Comparative Example, the larger the index the better the performance with respect to stability in handling.

<Braking Performance>

The respective tires were mounted on a vehicle in such fashion as to have negative camber, and this was driven on a dry road surface at 100 kilometers per hour, from which state the braking distance from application of full braking until standstill with operation of ABS was measured, reciprocals being calculated from the measured values. Results of evaluation are shown as indexed relative to a value of 100 for the Comparative Example, the larger the index the better the braking performance.

<Examples and Comparative Example>

The tire employed at Example 1 was such that the ratio (W1/W2) of the first distance W1 (distance between outer edge 3e in the tire width direction D1 of inboard shoulder main groove 3a and tire equatorial plane S1) to the second distance W2 (distance between outer edge 3f in the tire width direction D1 of outboard shoulder main groove 3b and tire equatorial plane S1) was 1.1.

The tire employed at Example 2 was such that the ratio (W1/W2) of the first distance W1 to the second distance W2 was 1.2.

The tire employed at Example 3 was such that the ratio (W1/W2) of the first distance W1 to the second distance W2 was 1.3.

The tire employed at Example 4 was such that the ratio (W1/W2) of the first distance W1 to the second distance W2 was 1.4.

The tire employed at the Comparative Example was such that the ratio (W1/W2) of the first distance W1 to the second distance W2 was 1.0.

<Results of Evaluation>

As shown in FIG. 5, at Examples 1 through 4, anti-hydroplaning performance was greater than 100, and performance with respect to stability in handling during turns was greater than 100. Accordingly, causing first distance W1 to be greater than second distance W2 will make it possible to improve anti-hydroplaning performance and performance with respect to stability in handling during turns when the tire is mounted on a vehicle in such fashion as to have negative camber.

Furthermore, a preferred example of a tire is described below.

Whereas braking performance was greater than 100 at Examples 1 through 3, braking performance remained unchanged, being 100, at Example 4. Accordingly, causing the ratio (W1/W2) of the first distance W1 to the second distance W2 to be not greater than 1.3 will make it possible to improve braking performance. It is thus preferred that the constitution of tire 1 be such that the ratio (W1/W2) of the first distance W1 to the second distance W2 is not greater than 1.3.

1. A pneumatic tire comprising:
a plurality of main grooves extending in a tire circumferential direction; and
an indicator region that indicates an orientation in which the tire is to be mounted on a vehicle;
wherein the plurality of main grooves comprise an inboard shoulder main groove that is arranged in inwardmost fashion when the tire is mounted on the vehicle, and an outboard shoulder main groove that is arranged in outwardmost fashion when the tire is mounted on the vehicle; and
wherein a distance between an outer edge in a tire width direction of the inboard shoulder main groove and a tire equatorial plane constituting a center in the tire width direction of the tire is greater than a distance between an outer edge in the tire width direction of the outboard shoulder main groove and the tire equatorial plane.

2. The pneumatic tire according to claim 1
wherein a void fraction attributable to an inboard region between the tire equatorial plane and a contact patch end arranged toward the inboard side when the tire is mounted on the vehicle is greater than a void fraction attributable to an outboard region between the tire equatorial plane and a contact patch end arranged toward the outboard side when the tire is mounted on the vehicle.

3. The pneumatic tire according to claim 2
wherein a void fraction attributable to at least one main groove in the inboard region is greater than a void fraction attributable to at least one main groove in the outboard region.

4. The pneumatic tire according to claim 3 further comprising a plurality of land portions that are partitioned by the plurality of main grooves and the pair of contact patch ends;
wherein each of the plurality of land portions respectively comprises at least one land groove; and
wherein a void fraction attributable to the at least one land groove in the inboard region is greater than a void fraction attributable to the at least one land groove in the outboard region.

5. The pneumatic tire according to claim 1
wherein total area of at least one of the main grooves which is arranged to the inboard side of the tire equatorial plane when the tire is mounted on the vehicle is greater than total area of at least one of the main grooves which is arranged to the outboard side of the tire equatorial plane when the tire is mounted on the vehicle.

6. The pneumatic tire according to claim 1 further comprising a plurality of land portions that are partitioned by the plurality of main grooves and the pair of contact patch ends;
wherein each of the plurality of land portions respectively comprises at least one land groove; and
wherein that land portion which of the land portions is arranged next-to-furthest toward the outboard side when the tire is mounted on the vehicle is in a shape of a rib that extends in continuous fashion in the tire circumferential direction.

7. The pneumatic tire according to claim 1
wherein each of the grooves has a width, the widths of the grooves increasing with increasing distance from the outboard side when the tire is mounted on the vehicle.

8. The pneumatic tire according to claim 1 further comprising a plurality of middle land portions that are partitioned by those main grooves which of the plurality of main grooves are respectively adjacent thereto;
wherein each of the middle land portions has a width, the widths of the middle land portions increasing with increasing distance from the inboard side when the tire is mounted on the vehicle.

9. The pneumatic tire according to claim 1 further comprising at least one middle land portion that is partitioned by those main grooves which of the plurality of main grooves are respectively adjacent thereto;
wherein the at least one middle land portion comprises a plurality of land grooves;
wherein the main grooves respectively adjacent thereto comprise a first main groove and a second main groove having a width larger than a width of the first main groove; and
wherein the plurality of land grooves are contiguous with the second main groove but are separated from the first main groove.
